(19) United States
(12) Patent Application Publication
(10) Pub. No.: US 2022/0405216 A1
(43) Pub. Date: Dec. 22, 2022

(54) SYSTEMS AND METHODS FOR DUAL CONNECTIVITY ON AN OPTICAL PORT

(71) Applicant: Dell Products L.P., Round Rock, TX (US)

(72) Inventors: Shree RATHINASAMY, Round Rock, TX (US); Maunish SHAH, Austin, TX (US)

(73) Assignee: Dell Products L.P., Round Rock, TX (US)

(21) Appl. No.: 17/349,679

(22) Filed: Jun. 16, 2021

(51) Int. Cl. G06F 13/20; H04B 10/40

(52) U.S. Cl. CPC G06F 13/20; H04B 10/40

(57) ABSTRACT

An active device module may include an active device, a housing configured to house the active device, and a plurality of breakout ports communicatively coupled to the active device, wherein each breakout port of the plurality of breakout ports is configured to receive a cable, wherein the active device and the plurality of breakout ports are configured such that one breakout port of the plurality of breakout ports at a time is selected and activated for communication to and from an information handling system into which the active device module is inserted.

### TECHNICAL FIELD

The present disclosure relates in general to information handling systems, and more particularly to systems and methods for providing for dual connectivity on an optical port, such as a port associated with an optical transceiver module.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An information handling system may have a network interface or other input/output (I/O) interface configured to receive an optical transceiver module (e.g., a small form-factor pluggable (SFP) transceiver or a quad small form-factor pluggable (QSFP) transceiver of any I/O speed). Such transceiver modules often plug into “cages” disposed on an I/O interface card, which often reside in the rear of the information handling system.

Many data centers and cloud environments often require elaborate cabling to couple different information handling systems to a network switch. In the case of cable issues or switch issues, physical intervention is often required, which may lead to numerous problems and disadvantages including, without limitation:
leaf switch pairs coupling to external switches may only have limited high speed ports for uplink connectivity;
leaf switch pairs typically cannot be connected to two pairs of external switches at the same time due to limited uplink ports;
an administrator must spend time to reconfigure cabling to move the cabling from one external switch to another;
an administrator must manually be present at the data center to change connections, which may be difficult in certain situations (e.g., during a pandemic);
frequently reconfiguring connectivity in test environments may be tedious;
cables may suffer wear and tear as they are often frequently plugged and unplugged in test environments;
transceiver modules may suffer wear and tear as they are often frequently plugged and unplugged in test environments; and
remote capability to switch connections on a single port to two different devices is not available using existing approaches.

### SUMMARY

In accordance with the teachings of the present disclosure, the disadvantages and problems associated with traditional approaches to networked connectivity may be reduced or eliminated.

In accordance with embodiments of the present disclosure, an active device module may include an active device, a housing configured to house the active device, and a plurality of breakout ports communicatively coupled to the active device, wherein each breakout port of the plurality of breakout ports is configured to receive a cable, wherein the active device and the plurality of breakout ports are configured such that one breakout port of the plurality of breakout ports at a time is selected and activated for communication to and from an information handling system into which the active device module is inserted.

In accordance with these and other embodiments of the present disclosure, a method may include housing an active device in a housing, communicatively coupling a plurality of breakout ports to the active device, wherein each breakout port of the plurality of breakout ports is configured to receive a cable, and configuring the active device and the plurality of breakout ports such that one breakout port of the plurality of breakout ports at a time is selected and activated for communication to and from an information handling system into which the active device is inserted.

In accordance with these and other embodiments of the present disclosure, a method may include, comprising, in an active device module comprising an active device, a housing configured to house the active device, and a plurality of breakout ports communicatively coupled to the active device, wherein each breakout port of the plurality of breakout ports is configured to receive a cable: selecting and activating one breakout port of the plurality of breakout ports at a time for communication to and from an information handling system into which the active device module is inserted.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example information handling system, in accordance with embodiments of the present disclosure;

FIG. 2 illustrates a perspective view of an example optical transceiver module, in accordance with embodiments of the present disclosure;

FIG. 3A illustrates a side elevation view of an example dual switching port breakout optical transceiver module, in accordance with embodiments of the present disclosure;

FIG. 3B illustrates a top plan view of the example dual switching port breakout optical transceiver module shown in FIG. 3A, in accordance with embodiments of the present disclosure;

FIG. 4A illustrates an elevation view of a front panel of an example information handling system, in accordance with embodiments of the present disclosure;

FIG. 4B illustrates a side view of the example information handling system shown in FIG. 4A, in accordance with embodiments of the present disclosure;

FIG. 5A illustrates a block diagram of selected components of an information handling system and dual switching port breakout optical transceiver module, in accordance with embodiments of the present disclosure;

FIG. 5B illustrates a block diagram of selected components of the information handling system and dual switching port breakout optical transceiver module depicting a first breakout port activated, in accordance with embodiments of the present disclosure; and

FIG. 5C illustrates a block diagram of selected components of the information handling system and dual switching port breakout optical transceiver module depicting a second breakout port activated, in accordance with embodiments of the present disclosure.

### DETAILED DESCRIPTION

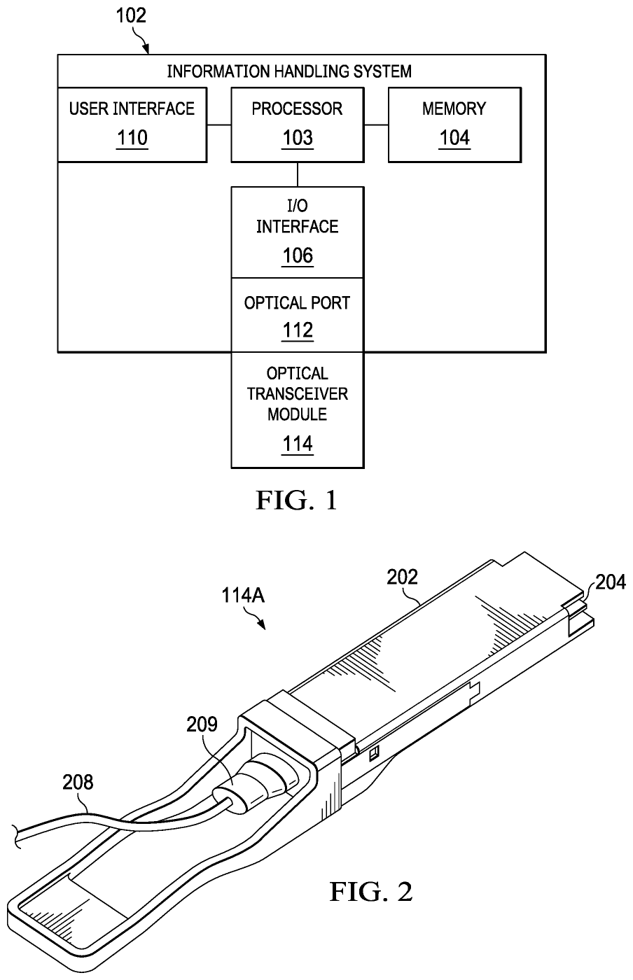

Preferred embodiments and their advantages are best understood by reference to FIGS. 1 through 5C, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

For the purposes of this disclosure, circuit boards may broadly refer to printed circuit boards (PCBs), printed wiring boards (PWBs), printed wiring assemblies (PWAs) etched wiring boards, and/or any other board or similar physical structure operable to mechanically support and electrically couple electronic components (e.g., packaged integrated circuits, slot connectors, etc.). A circuit board may comprise a substrate of a plurality of conductive layers separated and supported by layers of insulating material laminated together, with conductive traces disposed on and/or in any of such conductive layers, with vias for coupling conductive traces of different layers together, and with pads for coupling electronic components (e.g., packaged integrated circuits, slot connectors, etc.) to conductive traces of the circuit board.

FIG. 1 illustrates a functional block diagram of selected components of an example information handling system 102, in accordance with embodiments of the present disclosure. In some embodiments, information handling system 102 may be a personal computer (e.g., a desktop computer or a portable computer). In other embodiments, information handling system 102 may comprise a storage server for archiving data. In yet other embodiments, information handling system 102 may comprise a server. In further embodiments, information handling system 102 may comprise a network switch.

As depicted in FIG. 1, information handling system 102 may include a processor 103, a memory 104 communicatively coupled to processor 103, an input/output interface 106 communicatively coupled to processor 103, a user interface 110 communicatively coupled to processor 103, and an optical port 112 communicatively coupled to I/O interface 106.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, and/or another component of information handling system 102.

Memory 104 may be communicatively coupled to processor 103 and may include any system, device, or apparatus configured to retain program instructions and/or data for a period of time (e.g., computer-readable media). Memory 104 may include random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to its associated information handling system 102 is turned off.

I/O interface 106 may comprise any suitable system, apparatus, or device operable to serve as an interface between information handling system 102 and one or more other external devices. For example, in some embodiments, I/O interface 106 may comprise a network interface configured to serve as an interface between information handling system 102 and information handling systems via a network, in which case I/O interface 106 may comprise a network interface card, or “NIC.”

User interface 110 may comprise any instrumentality or aggregation of instrumentalities by which a user may interact with information handling system 102. For example, user interface 110 may permit a user to input data and/or instructions into information handling system 102, and/or otherwise manipulate information handling system 102 and its associated components. User interface 110 may also permit information handling system 102 to communicate data to a user, e.g., by way of a display device.

Optical port 112 may comprise an electrical connector in the form of any suitable combination of a jack, a socket, and/or “cage” for receiving a corresponding connector of an optical transceiver module 114.

Optical transceiver module 114 may include any system, device, or apparatus that houses and includes an optical transceiver configured to convert an incoming optical signal into an equivalent electrical signal, and communicate such equivalent electrical signal to I/O interface 106, and also configured to receive an electrical signal from I/O interface 106, convert such electrical signal into an equivalent optical signal, and communicate such optical signal as an outgoing optical signal (e.g., via an optical cable, which may be integral to the same assembly as optical transceiver module 114). Optical transceiver module 114 may include an SFP transceiver, a QSFP transceiver, or any other suitable form factor.

In addition to processor 103, memory 104, I/O interface 106, user interface 110, optical port 112, and optical transceiver module 114, information handling system 102 may include one or more other information handling resources. Such an information handling resource may include any component system, device or apparatus of an information handling system, including without limitation, a processor, bus, memory, I/O device and/or interface, storage resource (e.g., hard disk drives), network interface, electro-mechanical device (e.g., fan), display, power supply, and/or any portion thereof. An information handling resource may comprise any suitable package or form factor, including without limitation an integrated circuit package or a printed circuit board having mounted thereon one or more integrated circuits.

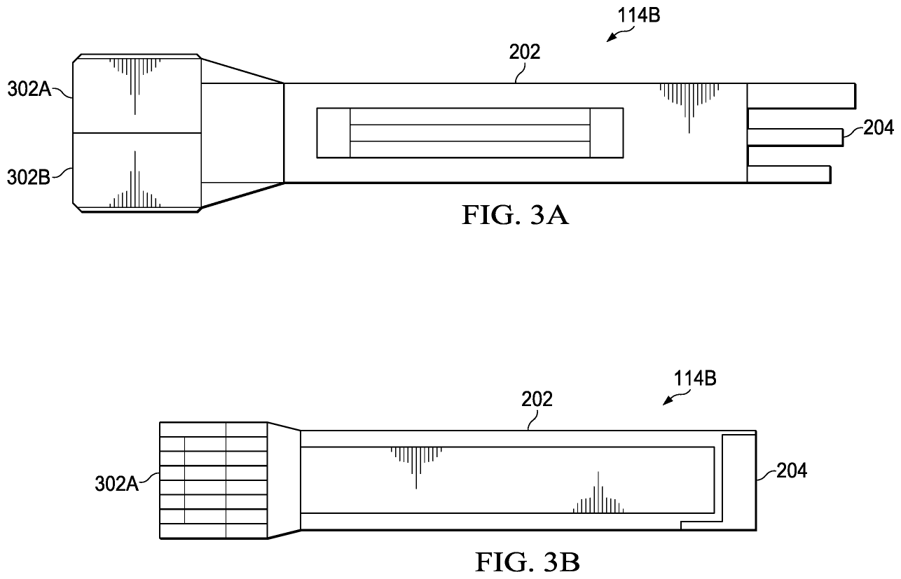

FIG. 2 illustrates a perspective view of an example optical transceiver module 114A and cable 208 inserted into optical transceiver module 114A, in accordance with embodiments of the present disclosure. In some embodiments, example optical transceiver module 114A depicted in FIG. 2 may be used to implement optical transceiver module 114 of FIG. 1. As shown in FIG. 2, optical transceiver module 114A may include a housing 202 for housing an optical transceiver 204 and one or more other components, a cable 208, and a strain relief feature 209. Housing 202 may comprise a metal enclosure configured to house and/or provide mechanical structure for optical transceiver 204, including mechanical features (e.g., guiding features) for aligning and/or mechanically securing optical transceiver 204 to I/O interface 106 via optical port 112. Optical transceiver 204 may include any system, device, or apparatus configured to receive an incoming optical signal (e.g., via cable 208), convert the incoming optical signal into an equivalent electrical signal, and communicate such equivalent electrical signal to I/O interface 106 (e.g., via optical port 112), and also configured to receive an electrical signal from I/O interface 106 (e.g., via optical port 112), convert such electrical signal into an equivalent optical signal, and communicate such optical signal as an outgoing optical signal (e.g., via cable 208).

Cable 208 may include any suitable system, device, or apparatus capable of passing optical signals therethrough. For example, cable 208 may include one or more optical fibers surrounded by optically opaque material and/or material for protecting such one or more optical fibers. Such one or more optical fibers integral to cable 208 may be optically coupled to optical transceiver 204, thus enabling communication with optical transceiver 204 via such optical fibers.

Strain relief feature 209 may mechanically enclose cable 208 and may be formed from any suitable material that may be configured to provide strain relief to cable 208 while also providing support to the extension of housing 202.

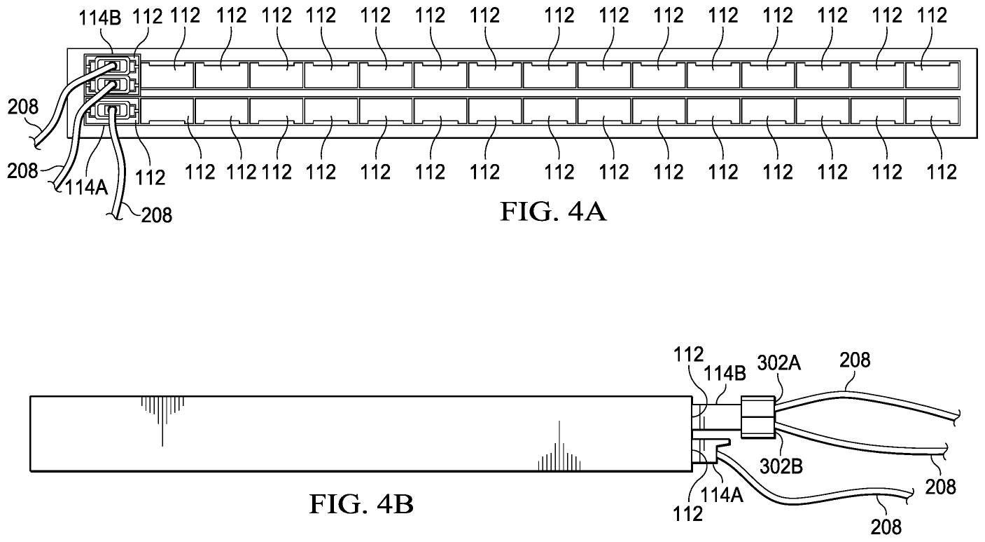

FIG. 3A illustrates a side elevation view of an example dual switching port breakout optical transceiver 114B module, in accordance with embodiments of the present disclosure. FIG. 3B illustrates a top plan view of example dual switching port breakout optical transceiver 114B module shown in FIG. 3A, in accordance with embodiments of the present disclosure. In some embodiments, example dual switching port breakout optical transceiver module 114B depicted in FIGS. 3A and 3B may be used to implement optical transceiver module 114 of FIG. 1.

As shown in FIGS. 3A and 3B, dual switching port breakout optical transceiver module 114B may be similar in many respects to optical transceiver module 114A, including a housing 202 and optical transceiver 204. However, unlike optical transceiver module 114A, which has only a single port for receiving a cable 208, dual switching port breakout optical transceiver module 114B may include a plurality of breakout ports 302 (e.g., breakout ports 302A and 302B), each configured to receive a respective cable 208.

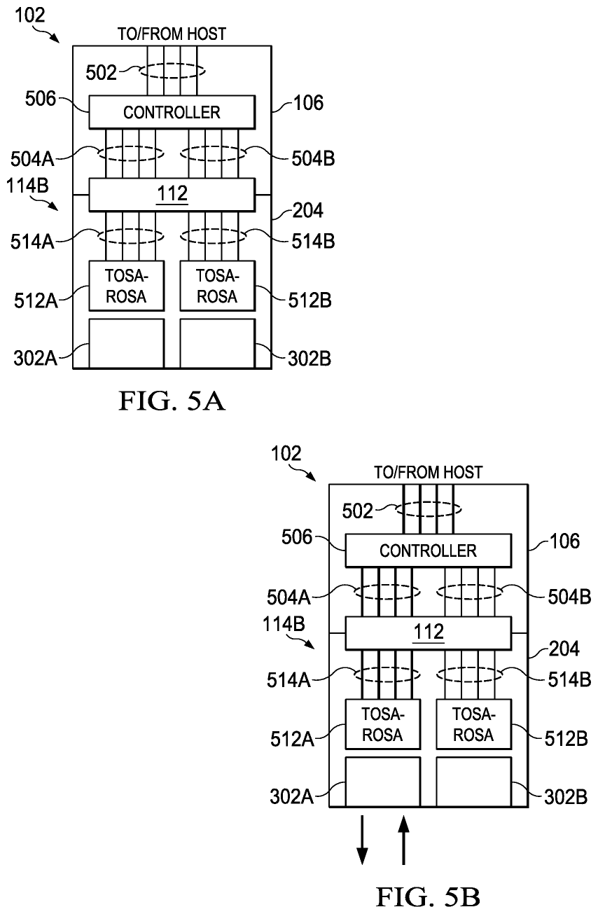

FIG. 4A illustrates an elevation view of a front panel of information handling system 102, in accordance with embodiments of the present disclosure. FIG. 4B illustrates a side view of information handling system 102, in accordance with embodiments of the present disclosure. In particular, FIGS. 4A and 4B illustrate a front panel of an information handling system 102 implemented as a network switch. As shown in FIGS. 4A and 4B, information handling system 102 may have a plurality of optical ports 112.

As also shown in FIGS. 4A and FIG. 4B, one or more optical ports 112 may be populated with optical transceiver modules 114A and one or more optical ports 112 may be populated with dual switching port breakout optical transceiver modules 114B. In turn, each optical transceiver module 114A may have a cable 208 coupled thereto and each dual switching port breakout optical transceiver module 114B may have multiple cables 208 coupled thereto via its breakout ports 302 (e.g., breakout ports 302A and 302B). As shown in FIG. 4B, a dual switching port breakout optical transceiver module 114B may be longer than a traditional optical transceiver module 114A, thus allowing for sufficient clearance with adjacent optical ports 112.

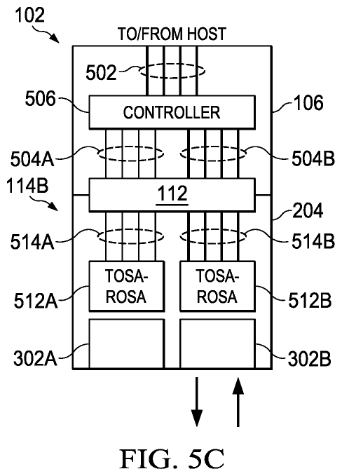

FIG. 5A illustrates a block diagram of selected components of information handling system 102 and dual switching port breakout optical transceiver module 114B, in accordance with embodiments of the present disclosure. As shown in FIG. 5A, I/O interface 106 of information handling system 102 may include a plurality of communications lanes 502 for communication with a host (e.g., processor 103) and a controller 506. Controller 506 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, controller 506 may be configured to perform some or all of the functionality of I/O interface 106.

As shown in FIG. 5A, controller 506 may interface between communication lanes 502 and each of a first set of communications lanes 504A and a second set of communications lanes 504B. In some embodiments, first set of communications lanes 504A and second set of communications lanes 504B may not be implemented using actual, physical communications lanes (e.g., electrically-conductive wires or traces), but may instead be implemented logically by controller 506.

Also as shown in FIG. 5A, optical transceiver 204 of dual switching port breakout optical transceiver module 114B may include its own first set of communications lanes 514A and second set of communications lanes 514B. First set of communications lanes 504A and second set of communications lanes 504B may be communicatively coupled to first set of communications lanes 514A and second set of communications lanes 514B, respectively, via optical port 112.

Further as shown in FIG. 5A, breakout port 302A may be communicatively coupled to first set of communications lanes 514A via a transceiver optical subassembly (TOSA)/receiver optical assembly (ROSA) 512A and breakout port 302B may be communicatively coupled to second set of communications lanes 514B via a TOSA/ROSA 512B. Each TOSA/ROSA 512 may include any system, device, or apparatus configured to convert optical signals into electrical signals and vice versa, as is known in the art.

In operation, to enable communication between a host (e.g., processor 103) of information handling system 102 and a first information handling system coupled to breakout port 302A via a cable 208, controller 506 may cause first set of communication lanes 504A and first set of communication lanes 514A to become active, as depicted in FIG. 5B. Likewise, to enable communication between a host (e.g., processor 103) of information handling system 102 and a second information handling system coupled to breakout port 302B via a cable 208, controller 506 may cause second set of communication lanes 504B and second set of communication lanes 514B to become active, as depicted in FIG. 5C.

Set forth below are example command-line interface instructions that an administrator or other user may input to information handling system 102 to cause breakout port 302B to become active:

OS (config) [symbol] int eth 1/1/1
OS (config) [symbol] breakout mode dual
OS [symbol] show interface status

| Port | Description | Status | Speed | Duplex | Mode | Vlan | Tagged-Vlans |
|---|---|---|---|---|---|---|---|
| Eth 1/1/1.a | To Switch2 | down | 100 G | full | — | | |
| Eth 1/1/1.b | To Switch3 | up | 100 G | full | — | | |
| Eth 1/1/2 | | up | 100 G | full | [symbol] | [symbol] | 1911 |

[symbol]

indicates data missing or illegible when filed

In practice, the opposite ends of cables 208 respectively coupled to breakout ports 302 may be coupled to different information handling systems. Accordingly, the systems and methods herein may enable an administrator or other user to, for a given optical port 112, select which of such cable-connected information handling systems shall be active for communication with such optical port, without requiring manual re-cabling of connectivity among networked components.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An active device module, comprising:
an active device;
a housing configured to house the active device; and
a plurality of breakout ports communicatively coupled to the active device, wherein each breakout port of the plurality of breakout ports is configured to receive a cable;
wherein the active device and the plurality of breakout ports are configured such that one breakout port of the plurality of breakout ports at a time is selected and activated for communication to and from an information handling system into which the active device module is inserted.

2. The active device module of claim 1, wherein the active device is an optical transceiver.

3. The active device module of claim 1, wherein the active device and the plurality of breakout ports are further configured such that the one breakout port is selected and activated by an input/output interface of the information handling system.

4. The active device module of claim 3, wherein the active device comprises:
a port interface configured to interface with the input/output interface;
a first set of communication lanes coupled between the port interface and the first breakout port of the plurality of breakout ports; and
a second set of communication lanes coupled between the port interface and the first breakout port of the plurality of breakout ports.

5. The active device module of claim 4, wherein the first set of communication lanes and the second set of communication lanes are configured such that:
the first set of communication lanes is selected and activated when the first breakout port is selected and activated for communication to and from the information handling system; and
the second set of communication lanes is selected and activated when the second breakout port is selected and activated for communication to and from the information handling system.

6. A method, comprising:
housing an active device in a housing;
communicatively coupling a plurality of breakout ports to the active device, wherein each breakout port of the plurality of breakout ports is configured to receive a cable; and
configuring the active device and the plurality of breakout ports such that one breakout port of the plurality of breakout ports at a time is selected and activated for communication to and from an information handling system into which the active device is inserted.

7. The method of claim 6, wherein the active device is an optical transceiver.

8. The method of claim 6, further comprising configuring the active device and the plurality of breakout ports such that the one breakout port is selected and activated by an input/output interface of the information handling system.

9. The method of claim 8, wherein the active device comprises:
a port interface configured to interface with the input/output interface;
a first set of communication lanes coupled between the port interface and the first breakout port of the plurality of breakout ports; and
a second set of communication lanes coupled between the port interface and the first breakout port of the plurality of breakout ports.

10. The method of claim 9, further comprising configuring the active device and the plurality of breakout ports such that:
the first set of communication lanes is selected and activated when the first breakout port is selected and activated for communication to and from the information handling system; and
the second set of communication lanes is selected and activated when the second breakout port is selected and activated for communication to and from the information handling system.

11. A method, comprising, in an active device module comprising an active device, a housing configured to house the active device, and a plurality of breakout ports communicatively coupled to the active device, wherein each breakout port of the plurality of breakout ports is configured to receive a cable:
selecting and activating one breakout port of the plurality of breakout ports at a time for communication to and from an information handling system into which the active device module is inserted.

12. The method of claim 11, wherein the active device is an optical transceiver.

13. The method of claim 11, wherein selecting and activating the one breakout port comprises selecting and activating the one breakout port by an input/output interface of the information handling system.

14. The method of claim 13, wherein the active device comprises:
a port interface configured to interface with the input/output interface;
a first set of communication lanes coupled between the port interface and the first breakout port of the plurality of breakout ports; and
a second set of communication lanes coupled between the port interface and the first breakout port of the plurality of breakout ports.

15. The method of claim 14, further comprising:
selecting and activating the first set of communication lanes when the first breakout port is selected and activated for communication to and from the information handling system; and
selecting and activating the second set of communication lanes when the second breakout port is selected and activated for communication to and from the information handling system.
